(19) United States
(12) Patent Application Publication
(10) Pub. No.: US 2010/0244593 A1
(43) Pub. Date: Sep. 30, 2010

(54) HOLDING APPARATUS FOR ELECTRICAL COMPONENTS OF A FIELD CIRCUIT WHICH ARE ARRANGED IN THE INTERIOR OF A ROTOR BODY, AS WELL AS A ROTOR HAVING A HOLDING APPARATUS SUCH AS THIS

(75) Inventors: RALF Cordes, Erlangen (DE); Walter Fischer, Muhldorf am Inn (DE); Jürgen Huber, Erlangen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/667,603

(22) PCT Filed: Jul. 1, 2008
(86) PCT No.: PCT/EP08/58412

§ 371 Date: May 17, 2010

(30) Foreign Application Priority Data
Jul. 4, 2007 (DE) 10 2007 030 969.6

(51) Int. Cl. H02K 5/22; H02K 9/22

(52) U.S. Cl. 310/52; 310/91

(57) ABSTRACT

The invention relates to a retaining device (100) for electrical components (103) of an excitation circuit arranged inside a rotor body (101) and to a rotor comprising said retaining device (100). The retaining device (100) extends on the interior of the rotor body (101) and is adapted to the rotor body (101) on its radially outer side in a form-fitting manner. On its radially inner side, the retaining device (100) comprises recesses or flattened sections (102) for receiving the electrical components (103) in a form-fit manner.

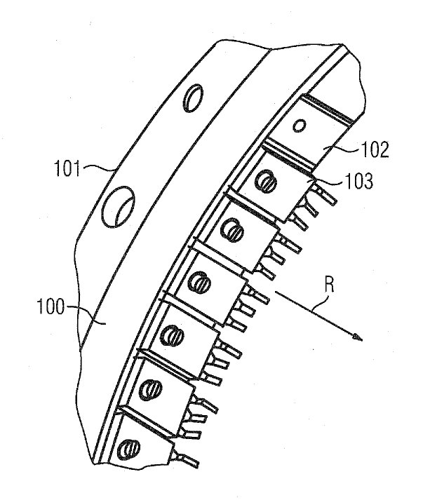

The invention relates to a holding apparatus for electrical components of a field circuit which are to be arranged in the interior of the rotor body of a rotor which is mounted such that it can rotate about an axis, and to a rotor having a holding apparatus such as this.

Electrical machines have field windings which are part of the rotor. In order to excite the winding, electrical machines have a field circuit which is arranged within the rotor of the electrical machine. Field circuits such as these have various electrical components, in particular power-electronic components.

A field circuit which is arranged within the rotor of an electrical machine is subject to considerable mechanical loads during operation of the electrical machine. In the case of a two-pole synchronous machine which is operated at a mains frequency of 60 Hz, the centripetal acceleration, for example, which acts on the electrical components of a field circuit which is arranged within the rotor of the electrical machine is several thousand g for typical housing sizes of machines such as these. Furthermore, a field circuit which is arranged within a rotor of an electrical machine is subject to the vibration which typically occurs in the rotor.

Furthermore, field circuits in some case have complex circuits which, in particular, comprise power-electronic components such as IGBTs, MOSFETs, thyristors, power diodes etc. Power-electronic components such as these cause not insignificant heat losses during operation, which must be dissipated from the area of the field circuit.

The object of the present invention is to specify a holding apparatus for the electronic components of a field circuit, which is improved with respect to the problems known from the prior art. One particular aim of the holding apparatus according to the invention is to achieve an improvement with respect to secure mechanical holding of the electrical components, with good dissipation of heat losses at the same time.

The object is achieved by the measures specified in claim 1. Accordingly, a holding apparatus is specified for electrical components of a field circuit which can be arranged in the interior of the rotor body of a rotor which is mounted such that it can rotate about an axis, wherein the holding apparatus extends in the circumferential direction of the rotor body on the inside thereof, and at least parts of its radially outer face are matched in an interlocking manner to the rotor body. The holding apparatus also has, on its radially inner face, recesses or flattened areas for interlocking accommodation of the electrical components.

The holding apparatus according to the invention allows the electrical components of a field circuit to be connected advantageously in a mechanically robust manner to a rotor body, while at the same time ensuring good dissipation of heat losses from the electrical components to the rotor body. Since the holding apparatus extends on the inside of the rotor body in the circumferential direction of the rotor body, the electrical components can be mounted physically close to the outside of the rotor body, where heat losses are dissipated. Furthermore, the electrical components can be arranged in the rotor body such that centripetal accelerations which act on the electrical components are absorbed the by holding apparatus.

Advantageous refinements of the holding apparatus according to the invention are specified in the claims which are dependent on claim 1. In this case, the holding the apparatus as claimed in claim 1 can be combined with the features of one, or in particular with the features of a plurality, of dependent claims. The holding apparatus according to the invention may also accordingly have the following features:
The electrical components may be power semiconductors. Secure mechanical holding while at the same time ensuring reliable heat dissipation are particularly advantageous for the power semiconductors in a field circuit.
The electrical components may have heat transfer surfaces and, furthermore, can make thermal contact over a large area by means of these heat transfer surfaces with the recesses or flattened areas of the holding apparatus. Furthermore, the recesses or flattened areas may be aligned such that their surface normals point essentially in the radial direction. Large-area thermal coupling of electrical components to the holding apparatus ensures a good thermal contact between the electrical components and the holding apparatus. Since the recesses or flattened areas of the holding apparatus, in which the electrical components are accommodated, are aligned such that their surface normals point essentially in the radial direction, the centripetal accelerations which act on the electrical components act essentially in the direction of the surface normals of the recesses or flattened areas. The forces which act on the electrical components in consequence do not lead to detachment of the electrical components from the holding apparatus and therefore to deterioration of the thermal contact between the electrical components and the holding apparatus but, in contrast to this, to an improvement in the thermal contact between the electrical components and the holding apparatus.
The electrical components may be screwed to the holding apparatus, or alternatively they may be connected to the holding apparatus by brackets. A screw- or bracket- connection of the electrical components to the holding apparatus allows the electrical components to be mounted easily and securely on the holding apparatus.
The holding apparatus may be manufactured from a thermally highly conductive material, in particular copper. A thermally highly conductive material such as copper improves the thermal coupling of the electrical components to the rotor body.
The holding apparatus may be part of the rotor body. A configuration of the holding apparatus such that it is an integrated component of the rotor body improves the mechanical and thermal coupling of the electrical components to the rotor body.

A further aim of the invention is to specify a rotor having a holding apparatus according to one of the preceding embodiments. In particular, in this case, the holding apparatus and the electrical components may be encapsulated in the interior of the rotor body. Encapsulation of the holding apparatus and of the electrical components in the interior of the rotor body has the advantage that it is possible to improve the thermal and mechanical link between the electrical components and the rotor body.

Further advantageous refinements of the holding apparatus according to the invention and of the rotor according to the invention will become evident from the dependent claims which have not been referred to above, and from the drawing which is explained in the following text.

In this case, the figure of the drawing shows a holding apparatus for electrical components which are arranged in the interior of the rotor body of a rotor.

The figure shows a part of a holding apparatus 100 which is arranged in the interior of a rotor body 101. In particular, the rotor body 101 can be mounted such that it can rotate about an axis, which is not illustrated in the figure. A direction R points in the direction of the rotation axis of the rotor body 101 for the purposes of the following illustration. In particular, the holding apparatus 100 is used to hold electrical components 103 of a field circuit or some other field device. The holding apparatus 100 is matched on its radially outer face (that is to say in the opposite direction to the direction R indicated in the figure) in the circumferential direction of the rotor body 101 to the shape of the rotor body 101, in particular in an interlocking manner and at least in parts. The holding apparatus 100 may also be matched in an interlocking manner to components which are directly connected to the rotor body 101 and in particular are thermally connected to the rotor body 101. On its radially inner face (in the direction R), the holding apparatus 100 has recesses or flattened areas 102 for interlocking accommodation of the electrical components 103. In particular, the electrical components (103) may be power-electronic components such as IGBTs, MOSFETs, thyristors, power diodes, etc.

The electrical components 103 may have heat transfer surfaces by means of which they make thermal contact over a large area with the recesses or flattened areas 102. The recesses or flattened areas 102 are also aligned such that their surface normals point essentially in the direction R.

Heat losses which occur in the electrical components 103 can be emitted to the holding apparatus 100 through the large-area contact between the electrical components 103 and the recesses or flattened areas 102. Furthermore, the holding apparatus 100 makes interlocking contact with the rotor body 101, such that the heat losses can be emitted essentially without any impediment to the rotor body 101, and therefore to the exterior.

Centripetal accelerations which act on the electrical components 103 as a result of rotation of the rotor body 101 are directed essentially in the direction of the surface normals of the recesses or flattened areas 102. Forces which act on the electrical components 103 as a result of such centripetal accelerations can thus be effectively absorbed by the holding apparatus 100.

The electrical components 103 may be screwed to the holding apparatus 100. Alternatively, the electrical components 103 may be connected to the holding apparatus 100 by brackets.

In particular, the holding apparatus 100 may be manufactured from a thermally highly conductive material such as copper, aluminum, alloys of these materials, etc. Furthermore, the holding apparatus 100 may itself also be an integrated part of the rotor body 101.

The holding apparatus 100 and the electrical components 103 may be encapsulated within the rotor body 101 by means of a suitable encapsulation compound. By way of example, one suitable encapsulation compound is synthetic resin which can be cured. The encapsulation of the holding apparatus 100 and of the electrical components 103 ensures a robust mechanical connection from the holding apparatus 100 and the electrical components 103 to the rotor body 101. Furthermore, the electrical components 103 are protected against influences, which occur in the area of the rotor body 101, which are damaging to the electronic components 103, such as dust, moisture, etc.

What is claimed is:

1-9. (canceled)

10. A holding apparatus for electrical components of a field circuit arranged in an interior space of a rotor body of a rotor mounted for rotation about an axis, the holding apparatus comprising:
a radially outer face extending in a circumferential direction and forming at least in parts a positive fit with an interior face of the rotor body, and
a radially inner face having at least one of recesses and flattened areas receiving the electrical components with a positive fit.

11. The holding apparatus of claim 10, wherein the electrical components comprise power semiconductors.

12. The holding apparatus of claim 10, wherein surface normals of the recesses or flattened areas point essentially in a radial direction of the holding apparatus, and wherein the electrical components comprise heat transfer surfaces having a surface area, with a substantial fraction of the surface area making thermal contact with the recesses or flattened areas.

13. The holding apparatus of claim 10, wherein the electrical components are secured to the holding apparatus with screws.

14. The holding apparatus of claim 10, wherein the electrical components are connected to the holding apparatus with brackets.

15. The holding apparatus of claim 10, wherein the holding apparatus is constructed of a material having a high thermal conductivity.

16. The holding apparatus of claim 15, wherein the material having the high thermal conductivity comprises at least one of copper and aluminum

17. The holding apparatus of claim 10, wherein the holding apparatus is an integral part of the rotor body.

18. A rotor mounted for rotation about an axis, comprising:
a rotor body having an interior face and defining an interior space;
electrical components of a field circuit arranged in the interior space; and
a holding apparatus for attachment of the electrical components, said holding apparatus having a radially outer face extending in a circumferential direction and forming at least in parts a positive fit with the interior face of the rotor body, and a radially inner face having at least one of recesses and flattened areas, with the electrical components received in the recesses or flattened areas with a positive fit.

19. The rotor of claim 18, wherein the holding apparatus and the electrical components are encapsulated in the interior space of the rotor body.
